(19) United States
(12) Patent Application Publication
(10) Pub. No.: US 2024/0070334 A1
(43) Pub. Date: Feb. 29, 2024

(54) METHOD AND SYSTEM FOR OPTIMIZATION OF THE EXTERNAL AND INTERNAL SHEATHING FOR THE CONSTRUCTION OF A BUILDING

(71) Applicant: Consulting Engineers, Corp., Reston, VA (US)

(72) Inventor: Maharaj Jalla, Great Falls, VA (US)

(21) Appl. No.: 18/373,369

(22) Filed: Sep. 27, 2023

Related U.S. Application Data
(63) Continuation-in-part of application No. 16/695,360, filed on Nov. 26, 2019, now abandoned.
Application No. 16/695,360 is a continuation-in-part of application No. 16/822,172, filed on Mar. 18, 2020, now abandoned.
Application No. 16/822,172 is a continuation-in-part of application No. 16/822,128, filed on Mar. 18, 2020.
Application No. 16/822,128 is a continuation-in-part of application No. 16/822,124, filed on Mar. 18, 2020, now abandoned.
Application No. 16/822,124 is a continuation-in-part of application No. 16/822,115, filed on Mar. 18, 2020.
Application No. 16/822,115 is a continuation-in-part of application No. 16/822,153, filed on Mar. 18, 2020, now abandoned.

(51) Int. Cl. G06F 30/12; G06F 30/13

(52) U.S. Cl. CPC G06F 30/12; G06F 30/13; G06F 2113/24

(57) ABSTRACT

The present invention is a computer method for determining and generating the sheathing materials required for the construction of a building, comprising; receiving, by one or more processors, a model of a structure, analysing, by one or more processors, the model of the structure to identify interior and exterior surfaces, identifying, by one or more processors, a surface type, wherein each surface type has a predetermined set of sheathing material panel types which can be applied to the surface type, receiving, by one or more processors, sheathing material properties via a user interface for each surface layer, wherein the surface layers are limited based on the surface types, receiving, by one or more processors, sheathing material layout parameters via a user interface for each of the surface types, calculating, by one or more processors, a layout of the sheathing material panels for each of the surfaces, and rendering, by one or more processors, an image of the sheathing material layout on each of the surfaces within the user interface.

### CROSS-REFERENCE TO RELATED APPLICATIONS

This application is a continuation-in-part (and claims the benefit of priority under 35 USC 120) of U.S. application Ser. No. 16/695,360 filed Nov. 26, 2019, U.S. application Ser. No. 16/822,172 filed Mar. 18, 2020, U.S. application Ser. No. 16/822,153 filed Mar. 18, 2020, U.S. application Ser. No. 16/822,144 filed Mar. 18, 2020, U.S. application Ser. No. 16/822,128 filed Mar. 18, 2020, U.S. application Ser. No. 16/822,124 filed Mar. 18, 2020, U.S. application Ser. No. 16/822,115 filed Mar. 18, 2020. The disclosure of the prior applications is considered part of (and is incorporated by reference in) the disclosure of this application.

### BACKGROUND

This disclosure relates generally to building construction and in particular, to the method, computer program, or computer system for providing the optimum materials required for the architectural sheathings of the external and internal surface of the building construction.

Building construction is a complicated process in which multiple disciplines are involved like architectural system which includes the building finishes, building fixed furniture arrangements, structural system which includes the structural framing members in the building, and other disciplines like mechanical system, electrical system, plumbing system.

During building construction, a large portion of the time is spent on the architectural finishing including the sheathing material used for the building. The framing is covered with the sheathing materials for finishing, appearance, insulation and fire proofing purpose. This is typically done by hand drawings, or computer-generated images or models to show the look of the finishing. Multiple calculations are required to determine the type of material, the thickness of the material and the like based on the environment and the design of the building. Many issues also arise by the inability of the designer to analyze the strength of the material and use over simplified mathematics to calculate the components of the building.

It is desired for a program or software to be able to determine the interior and exterior sheathing of a building when provided with a frame model of a building and based on a series of inputs or requirements. The program is able to generate an accurate and detailed breakdown of the interior and exterior sheathing while providing an optimum use of the sheathing material resulting in minimum waste of sheathing material and optimum use of the sheath.

### SUMMARY

In a first embodiment, the present invention is a computer method for determining and generating the sheathing materials required for the construction of a building, comprising; receiving, by one or more processors, a model of a structure, analyzing, by one or more processors, the model of the structure to identify interior and exterior surfaces, identifying, by one or more processors, a surface type, wherein each surface type has a predetermined set of sheathing material panel types which can be applied to the surface type, receiving, by one or more processors, sheathing material properties via a user interface for each surface layer, wherein the surface layers are limited based on the surface types, receiving, by one or more processors, sheathing material layout parameters via a user interface for each of the surface types, calculating, by one or more processors, a layout of the sheathing material panels for each of the surfaces, and rendering, by one or more processors, an image of the sheathing material layout on each of the surfaces within the user interface.

In a second embodiment, the present invention is a computer program product for determining and generating the sheathing materials required for the construction of a building, comprising; one or more computer readable non-transitory storage media and program instructions stored on the one or more computer readable non-transitory storage media, the program instructions comprising; receiving a model of a structure, identifying surfaces of the model, wherein sheathing material is to be applied to the identified surfaces, identify a surface type for each of the surfaces, wherein each surface type has a predetermined set of sheathing material panel types which can be applied to the surface type, receive via a user interface an input for a number of layers of sheathing material to be applied to one of the surfaces, and wherein the user interface is manipulated based on the number of layers selected, receive sheathing material layout parameters via a user interface, calculate a layout of the sheathing material panels for each of the surfaces, and render an illustration of the sheathing material layout of the surfaces within the user interface.

In a third embodiment, the present invention is a system for determining and generating the sheathing materials required for the construction of a building comprising; receiving a series of floor models related to a model of a structure, generating a 3D rendering of the model of the structure based on the series of floor models, identifying surfaces of the model which sheathing material can be applied to, identify a surface type for each of the surfaces, receive via a user interface an input for a number of layers of sheathing material to be applied to one of the surface types, and wherein the user interface is manipulated based on the number of layers selected, receive sheathing material layout parameters via a user interface, generate a layout of the sheathing material panels for each of the surfaces of the model, and render a first illustration of the sheathing material layout of a selected surface within the user interface and a second set of illustrations of the sheathing material panels of the selected surface within the user interface.

### BRIEF DESCRIPTION OF THE DRAWINGS

FIG. 1 depicts a block diagram depicting a computing environment, in accordance with one embodiment of the present invention.

FIG. 2 depicts a block diagram depicting the internal and external components of the server and computing device of FIG. 1, in accordance with one embodiment of the present.

FIG. 3 depicts a cloud computing environment, in accordance with one embodiment of the present invention.

FIG. 4 depicts a flowchart of the operational steps of a method for calculating and generating the sheathing requirements for the construction of a building within the computing environment of FIG. 1, in accordance with one embodiment of the present invention.

FIG. 5 depicts a user interface of the method for applying the sheathing material to the building, in accordance with one embodiment of the present invention.

FIG. 6 depicts a user interface of the method for applying the sheathing material to the building, in accordance with one embodiment of the present invention.

FIG. 7 depicts a user interface of the method for applying the sheathing material to the building, in accordance with one embodiment of the present invention.

FIG. 8 depicts an illustration of a portion of the building framing, in accordance with one embodiment of the present invention.

FIG. 9 depicts an illustration of the portion of the building framing with sheathing material panels superimposed over the frame members, in accordance with one embodiment of the present invention.

FIG. 10 depicts a user interface of the method for applying the sheathing material to the building, in accordance with one embodiment of the present invention.

### DETAILED DESCRIPTION

The present invention relates to the process of analyzing a building frame to determine the sheathing material requirements to adequately cover internal and/or an external surfaces of the building. This program analyzes the external and internal surfaces and develops the drawing of the sheathing material layout on the surface(s) and creates a model the building with the sheathing material applied. The architectural drawing provides the information for engineers and workers to know how the sheathing material is to be applied to the surfaces during construction. The sheathing material can be in multiple layers, and it is advantageous to know how these layers are applied and how each section of the sheathing material is cut to fit properly.

During building construction, the task of fixing the sheathing material to the frame is time consuming activity because measurement of the wall dimension, and cutting the wall sheathing material to require on site. Typically, a quantity of material of the sheathing material is purchased, and the workers cut the pieces as needed when installing. The sheathing material is in a standard size, however the wall dimensions are not always such that it fits full boards and this is where the majority of the waste of the sheathing material comes from, as the workers estimate the cuts and modifications to the sheathing material as they apply it.

The present invention provides an advantage over this tiresome and labor some process using the unique feature of the sheathing optimization program in which the data about the internal and/or external surfaces are identified from a 3-Dimensional structural model of the building frame. The program calculates precisely number and shape of all the sheathing material pieces needed and generates drawings for the surfaces to show the layout of the sheathing material panels, the dimensions of each sheathing material panels and the cutaways of the sheathing material panels from the “standard” panel size. The present invention can be used on any surface of the building that is within the 3D model, for example, but not limited to, the exterior walls, the interior walls, the floors, ceilings, roof surface, roof trusses, and the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

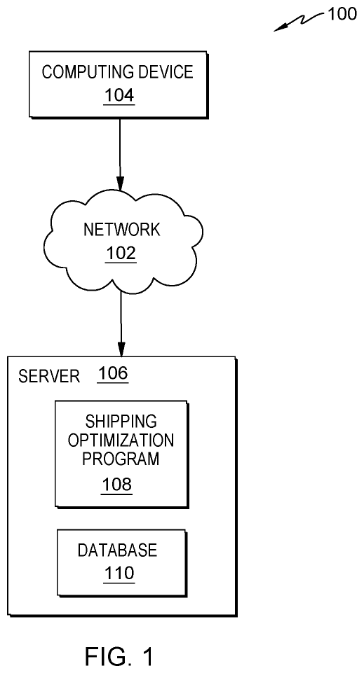

FIG. 1 depicts a block diagram of a computing environment 100 in accordance with one embodiment of the present invention. FIG. 1 provides an illustration of one embodiment and does not imply any limitations regarding the environment in which different embodiments maybe implemented.

In the depicted embodiment, computing environment 100 includes network 102, computing device 104, and server 106. Computing environment 100 may include additional servers, computers, or other devices not shown.

Network 102 may be a local area network (LAN), a wide area network (WAN) such as the Internet, any combination thereof, or any combination of connections and protocols that can support communications between computing device 104 and server 106 in accordance with embodiments of the invention. Network 102 may include wired, wireless, or fiber optic connections.

Computing device 104 may be a management server, a web server, or any other electronic device or computing system capable of processing program instructions and receiving and sending data. In other embodiments, computing device 104 may be a laptop computer, tablet computer, netbook computer, personal computer (PC), a desktop computer, or any programmable electronic device capable of communicating with patient computing device 104 via network 102. In other embodiments, computing device 104 may be a server computing system utilizing multiple computers as a server system, such as in a cloud computing environment. In one embodiment, computing device 104 represents a computing system utilizing clustered computers and components to act as a single pool of seamless resources. Computing device 104 may include components, as depicted and described in further detail with respect to FIG. 1.

Server 106 may be a management server, a web server, or any other electronic device or computing system capable of processing program instructions and receiving and sending data. In other embodiments server 106 may be a laptop computer, tablet computer, netbook computer, personal computer (PC), a desktop computer, or any programmable electronic device capable of communicating via network 102. In one embodiment, server 106 may be a server computing system utilizing multiple computers as a server system, such as in a cloud computing environment. In one embodiment, server 106 represents a computing system utilizing clustered computers and components to act as a single pool of seamless resources. In the depicted embodiment Sheathing Optimization Program 108 and database 110 are located on server 106. Server 106 may include components, as depicted and described in further detail with respect to FIG. 1.

Sheathing Optimization Program 108 has the unique feature of being able to take a constructed 3-Dimensional frame of a building, and through a plurality of calculations and determinations, can determine an interior and/or exterior sheathing for the building to meet specific requirements of the project. The Sheathing Optimization Program 108 is able to receive building architectural finishes that are either added by the user or predetermined by the Sheathing Optimization Program 108 and create the interior and/or exterior sheathing design, drawings, and features of the sheathing material for the project and also optimize the quantity needed for the project. Additionally, the Sheathing Optimization Program 108 is able to provide the arrangement of the sheathing material for each surface to provide optimized installation as well. Sheathing Optimization Program 108 determines the optimized and pre-cut size for each sheathing piece, thereby reducing the time required on the site for cutting of the sheathing material. By generating a 3D model of each piece of sheathing material and a drawing of each piece of sheathing material. A manufacturing facility can produce each piece exactly as required by the design. This is advantageous because the Sheathing Optimization Program 108 generates a building list, reduces the chances of the unnecessary extra material on site. In some embodiments, the Sheathing Optimization Program 108 is able to further identify the number and type of parts or material needed to secure the sheathing material to the frame. This feature avoids the overestimation of fasteners or securing means and provides the optimum quantity to order on site. In the depicted embodiment, Sheathing Optimization Program 108 utilizes network 102 to access the computing device 104 and to communicate with database 110. In one embodiment, Sheathing Optimization Program 108 resides on computing device 104. In other embodiments, Sheathing Optimization Program 108 may be located on another server or computing device, provided Sheathing Optimization Program 108 has access to database 110.

Database 110 may be a repository that may be written to and/or read by Sheathing Optimization Program 108. Information gathered from computing device 104 and the 1-dimensional, 2-dimensional, and 3-dimensional drawings and models as well as the requirements so that the materials and members are identified as conflicting or non-conflicting. In one embodiment, database 110 is a database management system (DBMS) used to allow the definition, creation, querying, update, and administration of a database(s). In the depicted embodiment, database 110 resides on computing device 104. In other embodiments, database 110 resides on another server, or another computing device, provided that database 110 is accessible to Sheathing Optimization Program 108.

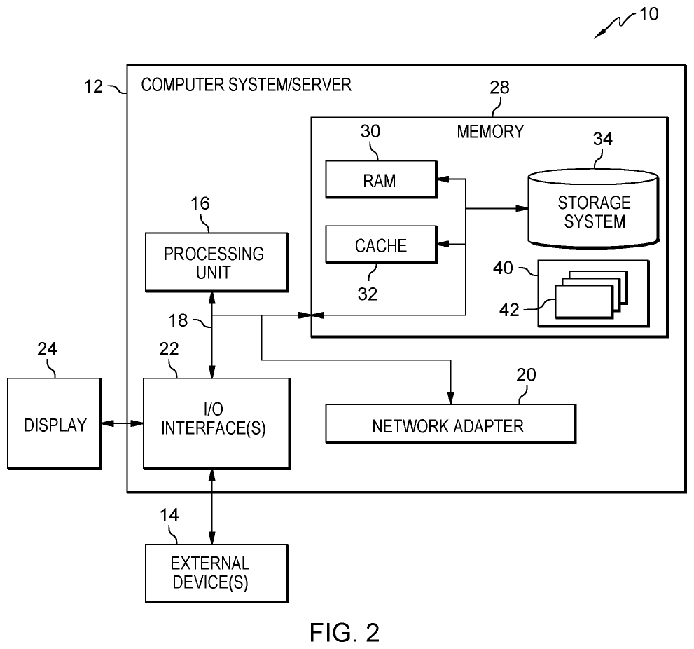

FIG. 2, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purposes or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

FIG. 2, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

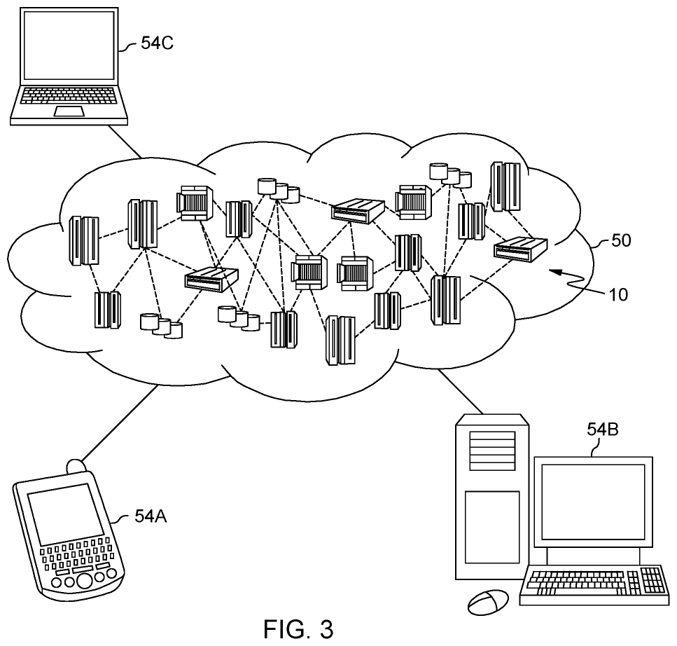

FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or additional computer systems may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-C shown in FIG. 2 are intended to be illustrative only and that computing nodes 10 and cloud computing environment 50 can communicate with any type of computerized device over any type of network and/or network addressable connection (e.g., using a web browser).

Referring back to FIG. 2, the Program/utility 40 may include one or more program modules 42 that generally carry out the functions and/or methodologies of embodiments of the invention as described herein. Specifically, the program modules 42 may monitor real-time parking facility camera data, receive vehicle identification information for a vehicle entering a parking facility, identify driver and vehicle information based on the vehicle identification information, identify open parking spaces based on the real-time parking facility camera data, determining attributes of the open parking spaces, score the open parking spaces based on the attributes, the vehicle information, and the driver information, select a particular open parking space based on the scoring, determine navigation directions to the selected parking space, and outputting navigation directions and information for the selected parking space, e.g., to a user device of the driver and/or to a vehicle interface system, such as a vehicle navigation system. Other functionalities of the program modules 42 are described further herein such that the program modules 42 are not limited to the functions described above. Moreover, it is noted that some of the modules 42 can be implemented within the infrastructure shown in FIGS. 1-3.

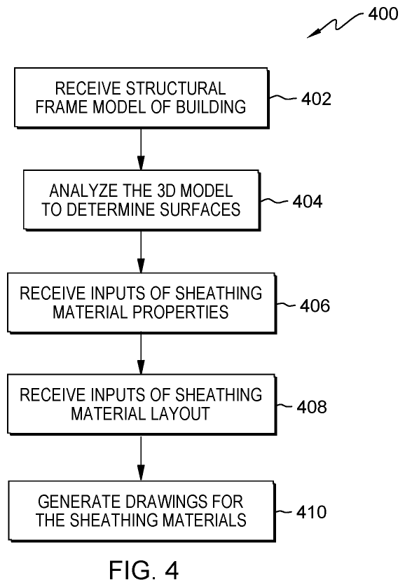

FIG. 4 depicts flowchart 400 depicting a method according to the present invention. The method(s) and associated process(es) are now discussed, over the course of the following paragraphs, in accordance with one embodiment of the present invention. The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

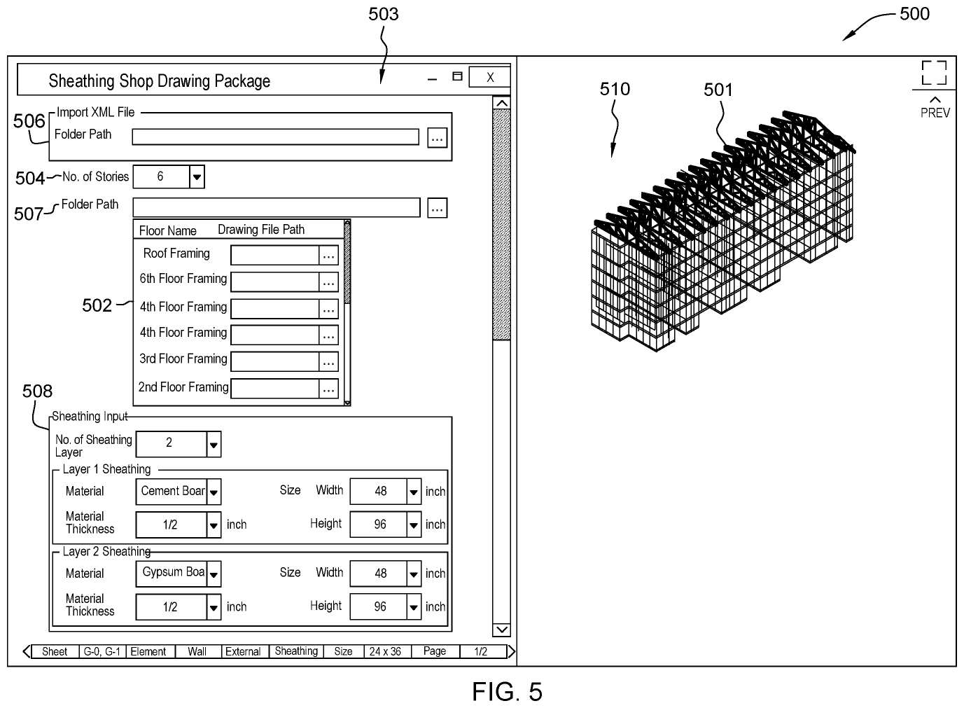

In step 402, the Sheathing optimization program 108, receives a model of the building, wherein the model consists of at least the frame members of the building. As shown in FIG. 5, the model of the building is shown as the frame of the building. This model has been cleared of all conflicts and the model provides a clear and accurate representation of the building. The 3D model is designed to be able to locate the position of each member. This model depicts all of the frame members, with all the connection points for the frame. In some embodiments, the model depicts a complete 3-Dimensional model where the frame members are cold formed steel. Typically the model is comprised of wall, floor, ceiling, roof, and roof truss members. The model may be a 3D model of the building, a series of 2D models of the building, or may be a set of drawings depicted the frame members and the necessary features to allow the Sheathing Optimization Program 108 to proceed through the following steps.

In step 404, the sheathing optimization program 108, analyzes the 3D model to determine all of the surfaces. The sheathing optimization program 108 analyzes the 3D model, 2D model, or drawings, to detect all the surfaces that sheathing material is able to be applied to, and determines what type of surface it is. For example, interior wall surface, interior floor surface, interior ceiling surface, roof, exterior wall, and the like. In some embodiments, the sheathing optimization program 108 determines what constitute a surface where sheathing could be applied to, and if that surface is an interior surface or an exterior surface. Based on the relative features of the model or drawings, the sheathing optimization program 108 is able to determine interior space versus exterior surfaces of the model. The sheathing optimization program 108 is able to calculate the dimensions of the surfaces. These dimensions include length, height, and any angles or sections of the wall which are not rectangular or square.

The sheathing optimization program 108 is able to determine where the frame members are positioned, the distance from and between the frame members, and the type of frame members, so that in the future steps the Sheathing Optimization Program 108 is able to determine the mounting points or location for the sheathing material panels.

In step 406, the sheathing optimization program 108 receives the inputs for the sheathing material properties. The sheathing optimization program 108 receives inputs from the user for specific sheathing material properties and completes the process of preparing the layout of the sheathing material panels for that surface or that surface type. As shown in FIG. 5, user interface 500 is shown having the input section 503 and section 510, which shows a visual of the model 501. Within input section 503 there is the file for the model is located 506, the number of stories of the building 504 is identified. In instances where drawings are input, section 502 allows the user to locate the various floor models if an entire building assembly is not input. Depending on whether the user uploads an entire model file or a series of model filed for each floor plan, 502, 507, 504, 506 will be accessible to the user, and the uploaded model files will populate into section 510. Section 508 is where the user if able to input various properties of the sheathing material and aspects of the layers of the sheathing material. As shown the number of layers, the sheathing material type, the sheathing material thickness, the width and height of each sheathing material panel can be input by the user. In some embodiments, some of these fields are automatically populated based on the user's selection. For example, if the user selected gypsum board, the standard size is populated into the following boxes. The number of sheathing layers selected modifies the number of options below for each sheathing material layer. The number of sheathing layer boxes which are created after this selection is ordered in a specific way based on the part of the building that is being assessed. In the depicted embodiment, layer 1 is the outside sheathing material layer and layer 2 is the inside sheathing material layer. This is important as many surfaces on a structure have multiple sheathing material layers, where the exterior layer is designed to be exposed to weather, and the interior layers are for structure, insulation, sound dampening, etc. The sheathing optimization program 108, is able to modify the descriptor of the layers, for example in the depicted embodiment it is “Layer 1 sheathing” and “Layer 2 sheathing”, the sheathing optimization program 108 can modify this descriptor to further help the user. For example it may be modified to “exterior layer” and “insulation layer”, or “interior layer” or the like. Based on the selection of the material in 508, specific data is collected from a database about the selected material type. With the increase in the number of layers of sheathing material there is a reciprocal entry for each layer. In the depicted embodiment two layers are selected and thus the user has two layers of material to input information/properties of In the depicted embodiment, that is material, material thickness, width, and height of the panels. Additional material may be required based on the type of sheathing material selected. For example, for a roof, where the material is asphalt shingles, the panel overlap length is required to create the sheathing material panel layout.

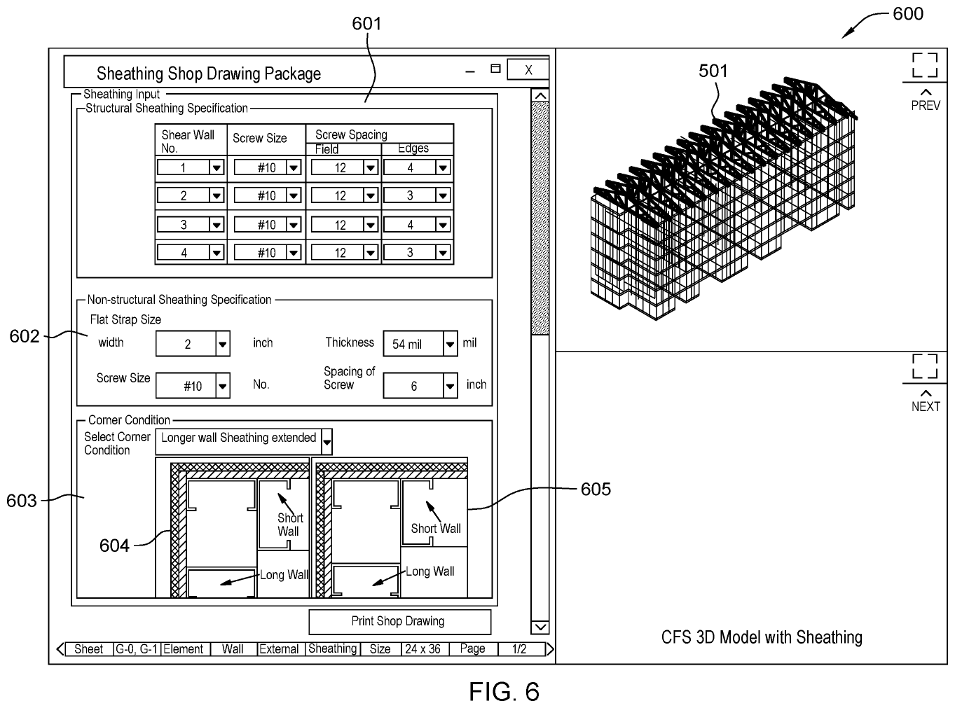

In step 408, the sheathing optimization program 108 receives the inputs for the sheathing material layout. For each type of surface there are various layout parameters which need to be set to determine that the sheathing material panels are properly positioned on the surface and any overlapping or positioning of the edges of the sheathing material panels is done correctly for the specific type of sheathing material type. The sheathing optimization program 108 receives inputs from the user for specific aspects and completes the process of preparing the layout of the sheathing material panels for that surface or that surface type. As shown in FIG. 6, a user interface 600 showing the sheathing material layout features are shown. The sheathing optimization program 108 is able to determine if the sheathing material types selected in user interface 508 are structural 601 or non-structural 602. This determination modifies the user interface 600 to present to the user sections 601 and section 602 if both structural and non-structural sheathing material types or present. In additional embodiments where only one type is present (structural or non-structural) the other section is removed from the user interface.

A structural sheathing material provides integrity or rigidity to the structure. Non-structural sheathing material provides insulation from heat, cold, sound, a finished surface for painting, and the like. The sheathing optimization program 108 is able to determine if the surface to which the sheathing material is being applied requires one or both of the sheathing material types and based on the selection in section 508. Based on the type of sheathing material being applied to the interior or exterior wall, selection sections 601 or 602 are presented to the user to select the required user inputs to collect adequate data to determine the sheathing material layout requirements or restrictions. In either situation of structural or non-structural sheathing material being applied, selection window 603 is presented to the user showing which corner condition is to be used for the sheathing material. As shown either the sheathing material overlaps on the short wall 604 or the long wall 605 and the user is required to select one. The depicted figure shows the sheathing material for an exterior wall, however in the operation of the sheathing optimization program 108, each wall type of processed through so that the entire buildings surfaces have the necessary sheathing material applied. In the depicted embodiment, the mode of the building 501 is presented to the user, similar to user interface 500.

In some embodiments, the sheathing optimization program 108 populates a set of know dimensions of a standard piece of sheathing material (e.g., drywall, roof shingles, insulation, plywood, etc.) in section 508.

In some embodiments, once the surface types (interior wall, exterior wall, ceiling, floor, roof, etc.) are determined, the sheathing material panel properties are identified, and the layout is determined for each of the surface types, the sheathing optimization program 108 is able to apply that sheathing material data to all like surface types. This is advantageous as it allows the sheathing material panel layout to all of the building surfaces saving the user time of having to go through every surface of the building.

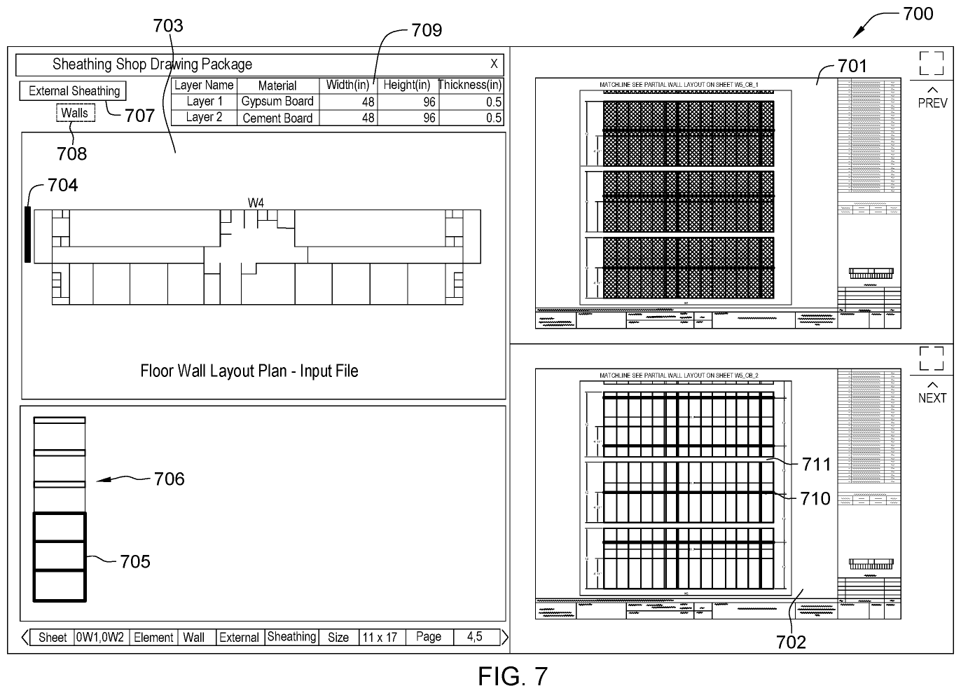

In step 410, sheathing optimization program 108 generates a set of drawings for the sheathing materials both for the wall layout as well as for each individual sheathing material panel dimensions. The sheathing optimization program 108 uses the provided data associated with the properties and layout of the sheathing material panel types to be applied. As shown in FIG. 7, a user interface 700 is shown. In this user interface, four (4) different views of the building are shown, section 703 showing a top view, section 706 showing a side view, section 701 showing a side view of the frame with the sheathing material panels applied and section 702 showing the frame of the building.

As shown in FIG. 7, a selection of a surface of the building is made, and the user interface is manipulated to show the user interface 700. Section 703 and 706 show different perspectives of the building model, which the user interacts with to select different surfaces of the model. In the depicted embodiment, section 703 is a section top view of the building and section 706 is a side view of the building. Highlighted portion 704 identifies the surface of the building which is selected by the user or the sheathing optimization program 108 that is shown in sections 701 and 702. What portion of the building that is highlighted in section 703 is populated in section 706 so that the same surface is visible in both views. In section 706 the number of floors is selected or determined by the user or the sheathing optimization program 108. sections 703 and 706 are interactive as the user is able to select various surfaces of the building and as the user interacts with sections 703 and 706, sections 701 and 702 are manipulated to match the user's selection. In the depicted embodiment in FIG. 7, the user has selected an exterior wall, and of that wall has selected three stories. The user is able to select any variety of number of walls and number of floors The selections of these surfaces are then populated into the drawings 701 and 702. In the depicted embodiment, drawing 701 is of the surface with the sheathing material applied, and drawing 702 is of the frame of the building. Depicted in the user interface is the identification of the sheathing material shown in boxes 707, 708, and 709. In the depicted embodiment, box 707 shows that this is an exterior sheathing material, box 708 indicates that it is a wall surface type, and box 709 provides the data about the sheathing material panel types and properties. These boxes 707, 708, and 709 are updated based on the highlighted surface 704 and 705. In drawings 701 and 702 the members 710 which are used for mounting the sheathing material panels and gaps 711, show the floor or space between each of the interior walls which are shown.

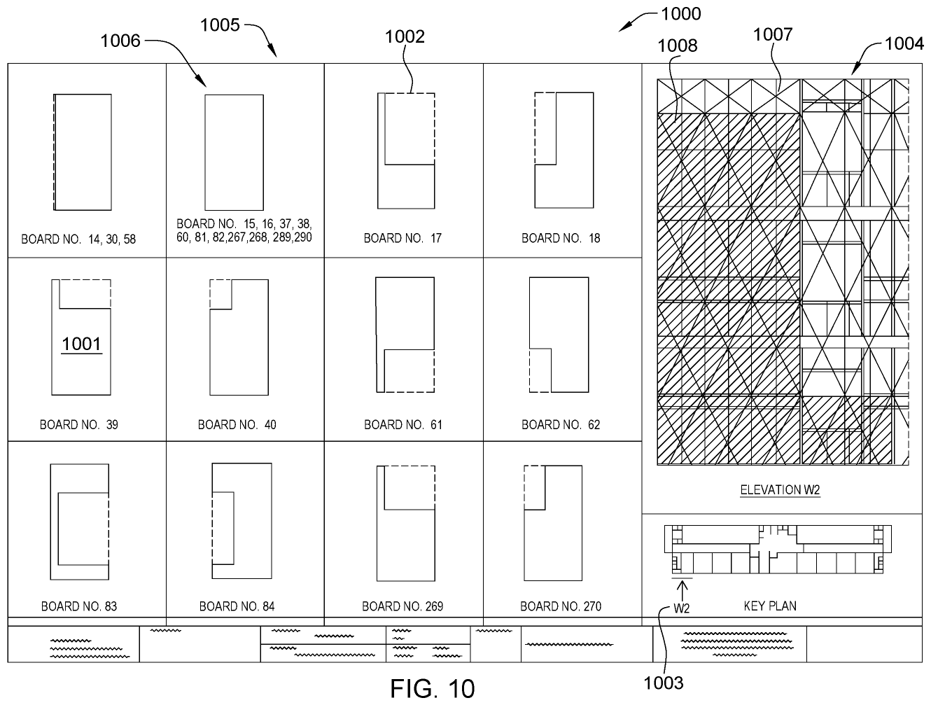

FIG. 10 depicts a user interface 1000 showing the section of the building and each of the sheathing material panel layouts for that section, in accordance with one embodiment of the present invention. As shown in the key plan, the user selects a section of the building, in this example that is section 1003 (identified as W2). Which is to populate the other sections of the user interface as shown. Upon the selection of 1003, area 1004 of the user interface is populated with a layout of the building frame as shown. The layout of this section of the building is shown with the sheathing material panels overlayed on the building frame so that the frame members are still visible. In some embodiments, the transparency of the sheathing material panels is modifiable and adjustable. This section of the building has various openings and apertures which are to remain free of the sheathing material panels (e.g., windows and doors). The sheathing material panels shown in area 1005 of the user interface depict each sheathing material panel that is needed to cover that section of the building. The sheathing material panels are shown in solid lines 1001 and dashed lines 1002 indicating the removed section of the sheathing material panels. In some embodiments, these images of each sheathing material panel have dimensions to show exactly how to manipulate/modify them to meet the requirements for the installation. Each sheathing material panel has a different number, and in each of the boxes a different sheathing material panel layout is shown within the user interface. In the depicted embodiment board 1006 shows multiple sheathing material panels that have the same dimensions. In the depicted embodiment of area 1004, there are two types of sheathing material panels shown panels 1007 and 1008. Panels 1008 are shown in section 1005, and panels 1007 are not shown. Panels 1007 are not shown as the user interface is limited in size. In some embodiments, there are multiple pages of section 1005 which the user is able to scroll though, and with the changing of the page, the area 1004 is updated based on the panels which are shown in area 1005.

These drawings include specific modifications to the sheathing material panels that are to be altered from their original size. A list of the sheathing material panels with the dimensions of the sheathing material panels is generated. In some embodiments, the drawings have mounting locations for the sheathing material panel based on the known frame member and the selections made during the previous steps. For example, if shiplap boards are used to cover the exterior of a structure, the sheathing optimization program 108 determined the mounting points of each sheathing material panel based on the frame members and the nail specifications selected during the previous steps and is able to generate the quantity of nails used and the location of each of the nails. The sheathing optimization program 108 is able to determine the location of each of the fasteners and the quantity to further assist the works, and provide a detailed bill of materials In some embodiments, the fastening locations are marked in the drawings or illustrations created by the sheathing optimization program 108. In some embodiments, the sheathing optimization program 108 is able to generate the dimensions of each sheathing material panel based on the overall dimensions of the surface. The sheathing optimization program 108 is able to optimize the alterations to the necessary pieces to both minimize waste material and installation time.

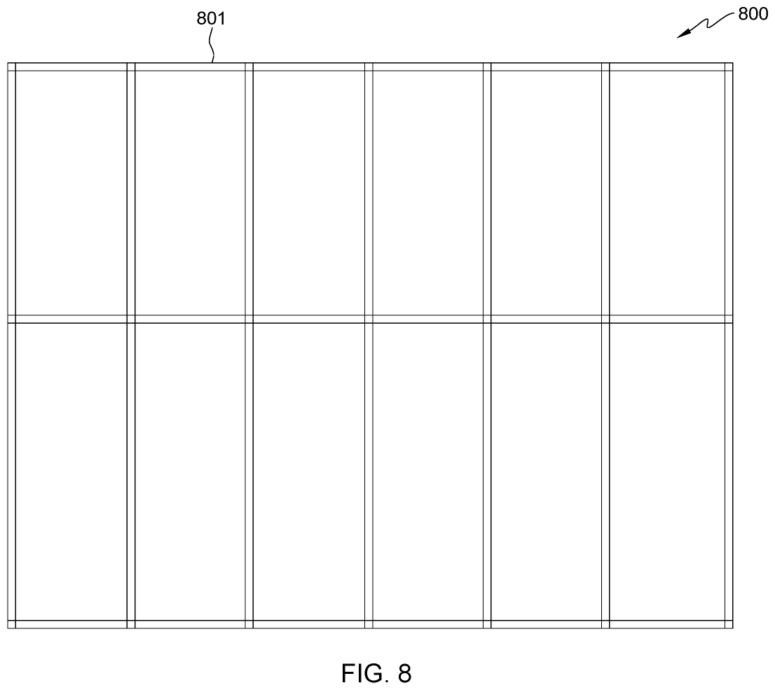

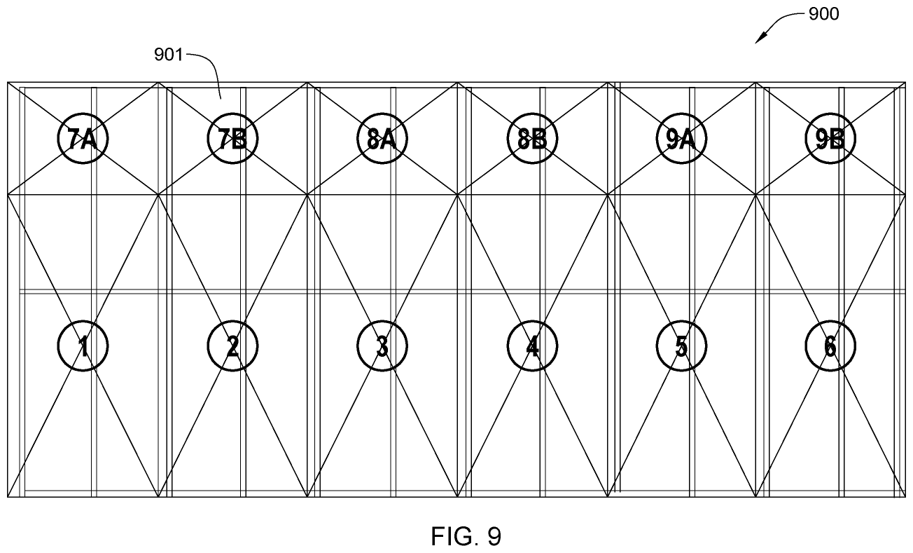

FIG. 8 depicts a view of a wall panel 800 with the members 801 visible. FIG. 9 shows the wall panel 800 with the sheathing material panels 901 applied to the wall, and the sheathing material panels marked (1-9B) based on the calculated layout of the sheathing material panels and the members 801. Each sheathing material panel is provided with a different number for easy identification and installation. Depicted is an example of a surface, where the sheathing optimization program 108 has identified the height and width of the surface, the height and width of the member, and the number and placement of each member which are all used to calculate the specific sheathing material panel size and placement. Based on the sheathing material panel properties and type, the sheathing optimization program 108 is able to determine the ideal placement of the sheathing material panels so that each sheathing material panel interfaces with at least the minimum number of members to be secured in place. This calculation considers all the features of the surface, for example doors and windows. These negative or open space areas are identified and included in the analysis of the surfaces.

In some embodiments, a 3D models of the sheathing material panels are made, and a new building model is created where the sheathing material panels are incorporated into the building model. This provides for a new 3D model that the user is able to interact with and manipulate.

The sheathing optimization program 108 when processing the sheathing material panel layout, the arrangement of the sheathing material panels also provides a number associated with each sheathing material panel, and the numbers coincide with the desired installation order of the sheathing material panel. By providing the order of installation, there further reduces the possibility of any waste material or incorrect installation of material.

In some embodiments, the sheathing optimization program 108 generates each sheathing material panel based on a set of features either preset, manually determined, or calculated by sheathing optimization program 108. These characteristics are related to the type of sheathing material panel, the number of layers of sheathing material, the installation requirements of the sheathing material, and the like. For example, the sheathing material panel for an interior space is, in one example, drywall that comes in a standard sheet size. For an exterior sheathing material plywood may be used for a structural sheathing material which comes in a standard sheet size. The dimensions of the sheathing material are known or collected to assist in generating the characteristics of the sheathing material panel.

It is understood that the examples of an exterior surface shown in the figures are used for exemplary purposes. The process is able to be applied to interior surfaces, floors, ceilings, roofs and all other surfaces of a building which a sheathing material can or would be applied to provided they are accessible within the model or drawings of the building.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A computer method for determining and generating the sheathing materials required for the construction of a building, comprising:
receiving, by one or more processors, a model of a structure;
analysing, by one or more processors, the model of the structure to identify interior and exterior surfaces;
identifying, by one or more processors, a surface type, wherein each surface type has a predetermined set of sheathing material panel types which can be applied to the surface type;
receiving, by one or more processors, sheathing material properties via a user interface for each surface layer, wherein the surface layers are limited based on the surface types;
receiving, by one or more processors, sheathing material layout parameters via a user interface for each of the surface types;
calculating, by one or more processors, a layout of the sheathing material panels for each of the surfaces; and
rendering, by one or more processors, an image of the sheathing material layout on each of the surfaces within the user interface.

2. The computer method of claim 1, wherein the images of the sheathing material layout are accessed via an interactive user interface.

3. The computer method of claim 1, further comprising, identifying, by one or more processors, a corner condition for the sheathing material layout.

4. The computer method of claim 1, wherein based on the surface type, the sheathing material is determined to be structural or non-structural.

5. The computer method of claim 1, further comprising, analysing, by one or more processors, the surfaces frame member positioning to determine a minimum number of interfaces the sheathing material panel has with frame members.

6. The computer method of claim 1, wherein the sheathing material panels are modified, by one or more processors, based on apertures on the surface which are to remain free of the sheathing material panels.

7. The computer method of claim 1, wherein the modification to the sheathing material panels is analysed based on an installation order of the sheathing material panels.

8. The computer method of claim 1, wherein the modification to the sheathing material panels is analysed to reduce wasted material of each sheathing material panel.

9. The computer method of claim 1, wherein based on a selection of a surface within the user interface, further comprising, manipulating, by one or more processors, various views of the surface within the user interface.

10. A computer program product for determining and generating the sheathing materials required for the construction of a building, comprising:
one or more computer readable non-transitory storage media and program instructions stored on the one or more computer readable non-transitory storage media, the program instructions comprising:
receiving a model of a structure;
identifying surfaces of the model, wherein sheathing material is to be applied to the identified surfaces;
identify a surface type for each of the surfaces, wherein each surface type has a predetermined set of sheathing material panel types which can be applied to the surface type;
receive via a user interface an input for a number of layers of sheathing material to be applied to one of the surfaces, and wherein the user interface is manipulated based on the number of layers selected;
receive sheathing material layout parameters via a user interface;
calculate a layout of the sheathing material panels for each of the surfaces; and
render an illustration of the sheathing material layout of the surfaces within the user interface.

11. The computer program product of claim 10, further comprising, determining a fastener type based on the sheathing material panel type and calculating the quantity and positioning of each of the fasteners based on the surface models.

12. The computer program product of claim 10, wherein the rendering of the illustration of the sheathing material layout is based on a user selection of a surface within the user interface.

13. The computer program product of claim 10, wherein the illustration of the sheathing material layout depicts the sheathing material panels superimposed over framing members of the selected surface.

14. The computer program product of claim 10, further comprising, generating a set of illustrations of each sheathing material panel for the selected surface.

15. The computer program product of claim 14, wherein each of the illustrations of the set of illustrations depicts a modification made to the sheathing material panel based on the framing member layout of the selected surface

16. A system for determining and generating the sheathing materials required for the construction of a building comprising:
receiving a series of floor models related to a model of a structure;
generating a 3D rendering of the model of the structure based on the series of floor models;
identifying surfaces of the model which sheathing material can be applied to;
identify a surface type for each of the surfaces;
receive via a user interface an input for a number of layers of sheathing material to be applied to one of the surface types, and wherein the user interface is manipulated based on the number of layers selected;
receive sheathing material layout parameters via a user interface;
generate a layout of the sheathing material panels for each of the surfaces of the model; and
render a first illustration of the sheathing material layout of a selected surface within the user interface and a second set of illustrations of the sheathing material panels of the selected surface within the user interface.

17. The system of claim 16, wherein the rendering of the first illustration, further comprises, selection in a user interface a surface of the model.

18. The system of claim 16, wherein the second set of illustrations depict modifications made to each of the sheathing material panels based on an underlying frame layout.

19. The system of claim 16, further comprising, determine a layout of the layers of sheathing material based on a selection of a corner condition.

20. The system of claim 16, further comprising, calculating a layout of fasteners based on the sheathing material panel layout.
